(19) United States
(12) Patent Application Publication
(10) Pub. No.: US 2024/0293843 A1
(43) Pub. Date: Sep. 5, 2024

(54) METHOD FOR SETTING RECOATING CONDITION OF WATER-REPELLENT COATING FILM

(71) Applicant: TOYODA GOSEI CO., LTD., Kiyosu-shi, Aichi-ken (JP)

(72) Inventors: Miki KITAMOTO, Kiyosu-shi, Aichi-ken (JP); Shintaro OKAWA, Kiyosu-shi, Aichi-ken (JP); Hiroaki ANDO, Kiyosu-shi, Aichi-ken (JP); Koji KUNO, Kiyosu-shi, Aichi-ken (JP)

(21) Appl. No.: 18/573,000

(22) PCT Filed: Jul. 14, 2022
(86) PCT No.: PCT/JP2022/027754

§ 371 Date: Dec. 21, 2023

(30) Foreign Application Priority Data
Jul. 30, 2021 (JP) 2021-125732

(51) Int. Cl. B05D 3/12; B05D 7/02

(52) U.S. Cl. CPC B05D 3/12; B05D 7/02; B05D 2201/00; B05D 2252/00

(57) ABSTRACT

To provide a technique of continuously imparting favorable water-repellent performance to a vehicle exterior member for a long period.

A method for setting a condition for recoating a vehicle exterior member with a water-repellent coating film, the method including:
a peeling step of peeling a water-repellent coating film formed on a surface of the vehicle exterior member;
a recoating step of forming a water-repellent coating film onto the surface to obtain a coating-film-formed vehicle exterior member, the recoating step being subsequent to the peeling step; and
an assessment step of adhering a test liquid drop onto the water-repellent coating film formed through the recoating step, and making a water-repellency assessment, wherein
the assessment step includes making, when a fall-off angle of the test liquid drop is not greater than 20°, an assessment that a recoating condition used in the peeling step and the recoating step is an acceptable recoating condition.

### TECHNICAL FIELD

The present invention relates to a method for setting a condition for recoating a vehicle exterior member with a water-repellent coating film.

### BACKGROUND ART

Vehicle exterior members are sometimes required to have water repellency.

In recent years, vehicles are generally mounted with various types of radars in order to ensure safety in traveling, protection of pedestrians, and the like. For example, in a remote sensing technology called light detection and ranging (LiDAR), the distance between an object and a vehicle is measured by a radar. Specifically, the radar radiates near-infrared light, visible light, ultraviolet light, or the like to an object and detects reflected light thereof.

In addition, there is a system for maintaining the speed of a vehicle that is traveling. The system is called a cruise control system or an autocruise system. In this system, the distance between a preceding vehicle and the vehicle under the control of the system is measured by a radar. The radar radiates a millimeter wave or a laser wave to a region in front of the vehicle and detects reflected light thereof.

Each of these radars is ordinarily disposed on the inner side (i.e., vehicle body side) relative to a vehicle exterior member. In this case, adhesion of many water drops onto the vehicle exterior member causes difficulty in performing high-accuracy sensing by the radar through the vehicle exterior member.

This problem is expected to be solved or mitigated by imparting water repellency to the vehicle exterior member (see, for example, Patent Literatures 1 and 2).

### CITATION LIST

### Patent Literature

Patent Literature 1: JPH9-187725 (A)
Patent Literature 2: JP4395628 (B)

### SUMMARY OF INVENTION

### Technical Problem

Patent Literature 1 discloses a technique of forming a protective coating onto a coating film on a bodyshell of a vehicle, such as a bonnet. In addition, Patent Literature 2 discloses a technique of forming a water-repellent coating onto a coating film on a bodyshell of a vehicle, such as a ceiling portion.

When either of the coatings disclosed in Patent Literatures 1 and 2 is formed onto a vehicle exterior member disposed on the outer side relative to a radar, water drops are considered to be inhibited from being adhered onto the vehicle exterior member.

Meanwhile, further usage of a general protective coating or a general water-repellent coating leads to further degeneration of the coating and further deterioration of the performance of the coating. Therefore, even when either of the protective coating and the water-repellent coating respectively disclosed in Patent Literatures 1 and 2 is formed onto a vehicle exterior member, continuous imparting of favorable water-repellent performance to the vehicle exterior member for a long period is difficult.

The present invention has been made in view of the above circumstances, and an object of the present invention is to provide a technique of continuously imparting favorable water-repellent performance to a vehicle exterior member for a long period.

### Solution to Problem

A method for setting a recoating condition of a water-repellent coating film of the present invention for solving the above problem is
a method for setting a condition for recoating a vehicle exterior member with a water-repellent coating film, the method including:
a peeling step of peeling a water-repellent coating film formed on a surface of the vehicle exterior member;
a recoating step of forming a water-repellent coating film onto the surface to obtain a coating-film-formed vehicle exterior member, the recoating step being subsequent to the peeling step; and
an assessment step of adhering a test liquid drop onto the water-repellent coating film formed through the recoating step, and making a water-repellency assessment, wherein
the assessment step includes making, when a fall-off angle of the test liquid drop is not greater than 20°, an assessment that a recoating condition used in the peeling step and the recoating step is an acceptable recoating condition.

### Advantageous Effects of Invention

The method for setting a recoating condition of a water-repellent coating film of the present invention allows continuous imparting of favorable water-repellent performance to a vehicle exterior member for a long period.

### BRIEF DESCRIPTION OF DRAWINGS

FIG. 1 is a graph showing changes in a fall-off angle and a contact angle among coating-film-formed vehicle exterior members resulting from first to fourth times of recoating; and

FIG. 2 is a graph showing changes in the fall-off angle and the contact angle among the coating-film-formed vehicle exterior members resulting from first to fourth times of recoating.

### DESCRIPTION OF EMBODIMENTS

Hereinafter, an embodiment of the present invention is described. Unless otherwise specified, a numerical value range “a to b” described herein includes the lower limit “a” and the upper limit “b” in the range. A numerical value range may be formed by arbitrarily combining such upper limit and lower limit values and numerical values described in the embodiment and the like. In addition, numerical values arbitrarily selected from within a numerical value range may be used as upper limit and lower limit numerical values.

A method for setting a recoating condition of a water-repellent coating film of the present invention is based on the premise that the water-repellent coating film experiences deterioration of the durability thereof. With this premise, the method is intended for continuously imparting favorable water-repellent performance to a vehicle exterior member for a long period by: peeling the water-repellent coating film having experienced deterioration of the durability thereof; and recoating, i.e., coating again, the vehicle exterior member with such a water-repellent coating film. Furthermore, the method is intended for, by assessing in advance whether or not the water-repellent coating film formed through the recoating has favorable water-repellent performance, setting a condition for a peeling step and a recoating step, i.e., a condition for appropriately performing recoating with a water-repellent coating film for a coating-film-formed vehicle exterior member mounted on an actual vehicle.

A detailed condition for the peeling step and the recoating step variously differs depending on, for example, the shape and the material of the vehicle exterior member and the composition or the like of a paint used for a water-repellent coating film.

Considering this, the method for setting a recoating condition of a water-repellent coating film of the present invention is performed in advance for each of combinations of paints and vehicle exterior members, and an optimum water-repellent coating film recoating condition corresponding to the combination is set. Consequently, recoating with a water-repellent coating film for a coating-film-formed vehicle exterior member mounted on an actual vehicle is stably performed at a constant level in various occasions, environments, or situations.

In other words, employment of the method for setting a recoating condition of a water-repellent coating film of the present invention allows a service of recoating with a water-repellent coating film to be performed with a stable quality across different business categories and shops such as dealers, car accessory shops, and gas stations.

Consequently, the method for setting a recoating condition of a water-repellent coating film of the present invention allows continuous imparting of favorable water-repellent performance to a coating-film-formed vehicle exterior member mounted on an actual vehicle, for a long period.

Hereinafter, the method for setting a recoating condition of a water-repellent coating film of the present invention is described in connection with each step of the method. In addition, hereinafter, the method for setting a recoating condition of a water-repellent coating film of the present invention is sometimes referred to as the condition setting method of the present invention, as necessary.

The condition setting method of the present invention includes a peeling step, a recoating step, and an assessment step.

Among these steps, the peeling step is a step of peeling a water-repellent coating film formed on a surface of a vehicle exterior member.

The vehicle exterior member only has to be a vehicle exterior member that may have a water-repellent coating film formed thereon or a vehicle exterior member that is suitable for having a water-repellent coating film formed thereon. The vehicle exterior member is not particularly limited in terms of use, the shape, the material, or the like thereof, but is preferably for being disposed on the outer side relative to a radar device such as one of the radar devices described above.

In the condition setting method of the present invention, the material of the vehicle exterior member is not limited and is exemplified by resin materials such as polycarbonates (PC), acrylics, and acrylonitrile-butadiene-styrene-copolymer synthetic resins (ABS).

As the vehicle exterior member, a vehicle exterior member on which any type of coat layer is formed may be used. For example, a coat layer such as a hard coat layer may be formed onto a base material made from any of the above resin materials.

The vehicle exterior member is also not particularly limited in terms of the size thereof, and may be a small-sized vehicle exterior member such as an emblem or a large-sized vehicle exterior member such as a front grille.

The water-repellent coating film only has to have water repellency. The water repellency mentioned herein means a characteristic of repelling water or a characteristic of having a low compatibility with water. The water-repellent coating film preferably has excellent weather resistance so as to be formed onto the surface of the vehicle exterior member.

Specifically, as a paint for the water-repellent coating film, any type of water-repellent or hydrophobic paint may be used, and a fluorine-based paint is particularly suitable.

In particular, as the paint for the water-repellent coating film, a paint obtained by dissolving, in a solvent, a silane coupling agent and a curing component such as a metal alkoxide, as disclosed in JP2016-147469 (A), is more preferably used. The solvent preferably includes: a solvent having either an alcohol group or a ketone group; or a solvent having a comparatively high boiling point, such as a water-soluble solvent.

The water-repellent coating film may be directly formed onto the vehicle exterior member or may be formed onto a primer layer formed on the vehicle exterior member.

In the peeling step of the condition setting method of the present invention, the water-repellent coating film formed on the surface of the vehicle exterior member only has to be peeled through any method. In the peeling step, for example, a chemical-peeling method in which the water-repellent coating film is dissolved by using an organic solvent such as methyl ethyl ketone (MEK) or ethanol, an alkali or a water-soluble solvent, or the like may be employed, a physical-peeling method in which the water-repellent coating film is scraped off by using a file, a brush, a wiper made of paper or a nonwoven fabric, or the like may be employed, or these methods may be employed in combination.

Here, in the above peeling step, the water-repellent coating film only has to be peeled, and lower layers (for example, the primer layer and the hard coat layer described above) relative to the water-repellent coating film may remain on the vehicle exterior member even after the peeling step without being peeled.

There is a possibility that each of these lower layers and the vehicle exterior member is damaged in the peeling step. Therefore, in a case where, for example, excessive force is applied in the peeling step or the peeling step is repeated, there is a concern that the smoothness of each of the lower layers and the vehicle exterior member are impaired. In such a case, there is a possibility that the water-repellent coating film formed through recoating is comparatively firmly integrated with the lower layers or the vehicle exterior member owing to the anchor effect, whereby sufficient peeling becomes difficult to perform during the next time of recoating.

Therefore, the peeling step is preferably performed such a number of times and with such a strength that the water-repellent coating film is sufficiently peeled from the vehicle exterior member. The amount of the water-repellent coating film remaining on the surface of the vehicle exterior member after the peeling step with respect to 100 area % of an arbitrarily-determined measurement region on the surface of the vehicle exterior member, is preferably not greater than 10 areas, more preferably not greater than 5 area %, and particularly preferably not greater than 3 area %. Determination as to this amount may be performed through image processing of an image acquired with a microscope.

When the water-repellent coating film is peeled such that this amount falls within the above range, the surface of the vehicle exterior member looks smooth.

Therefore, in a case where a condition set through the condition setting method of the present invention is used to perform recoating with respect to a water-repellent coating film on a coating-film-formed vehicle exterior member mounted on an actual vehicle, determination as to whether or not the peeling step has been completed may be performed through measurement of the mass of the vehicle exterior member or may be visually performed by an operator. Alternatively, the determination may be performed by another means such as image analysis.

The recoating step is a step of forming a water-repellent coating film onto the surface of the vehicle exterior member having been subjected to the peeling step. The water-repellent coating film formed through the recoating step may be the same as, or different from, the water-repellent coating film peeled in the peeling step. In a case where the water-repellent coating film remains after the peeling step, the same water-repellent coating film as the water-repellent coating film peeled in the peeling step is preferably formed in the recoating step in consideration of the compatibility with the water-repellent coating film remaining after the peeling step.

The recoating step only has to be performed through a general painting method. Examples of the general painting method include: a method in which a paint is applied onto the vehicle exterior member by using an applicator such as a brush or a sponge; a method in which a paint is sprayed onto the vehicle exterior member by using a spray; and a method in which the vehicle exterior member is dipped in a paint.

Then, the solvent contained in the paint applied or otherwise adhered onto the vehicle exterior member is removed as necessary through drying, heating, or the like. Consequently, the vehicle exterior member is recoated, whereby a coating-film-formed vehicle exterior member is obtained.

In the condition setting method of the present invention, the assessment step is performed after the recoating step. Specifically, in the assessment step, a test liquid drop is adhered onto the water-repellent coating film formed through the recoating step, and a water-repellency assessment is made. When a fall-off angle of the test liquid drop is not greater than 20°, an assessment that the relevant recoating condition, i.e., the recoating condition used for the peeling step and the recoating step, is an acceptable recoating condition is made.

In the case of an acceptable recoating condition, the relevant water-repellent coating film is considered to have a sufficient water-repellent function, and the peeling step and the recoating step are also considered to have been appropriately performed. That is, when the assessment obtained in the assessment step indicates that the relevant recoating condition is an acceptable recoating condition, this condition is determined to: allow the vehicle exterior member to be appropriately recoated; and be suitable for obtaining a coating-film-formed vehicle exterior member having a sufficient water-repellent function. Consequently, the condition setting method of the present invention allows appropriate setting of a condition for the peeling step and the recoating step such that recoating with a water-repellent coating film is appropriately performed.

The fall-off angle mentioned herein means an angle measured when a test liquid drop on the coating-film-formed vehicle exterior member falls off as a result of tilting the coating-film-formed vehicle exterior member. More specifically, with a test liquid drop being adhered onto the coating-film-formed vehicle exterior member which is a test object, a sample stage on which the coating-film-formed vehicle exterior member is placed or held is tilted while the test liquid drop is being captured by a high-speed camera. Then, the difference between the angle of the sample stage in an initial state and the angle of the sample stage measured when the test liquid drop falls off from the coating-film-formed vehicle exterior member, is regarded as a fall-off angle. The fall-off angle is considered as a dynamic index for water repellency.

As a liquid for forming the above test liquid drop, a liquid that contains at least a liquid medium and that contains, as necessary, an additive added to the liquid medium may be used. The liquid medium may be aqueous or nonaqueous. However, in consideration of the fact that the coating film has water repellency, the liquid medium preferably contains at least 50 volume % of water. As the water, general water such as tap water, ion exchanged water, or distilled water may be used. As a matter of course, the liquid for forming the test liquid drop is also preferably a liquid consisting of any of these waters, i.e., a liquid containing 100 volume % of the water.

The above additive is preferably an additive that allows reproduction of a composition similar to the composition of a liquid drop that is actually adhered on the coating-film-formed vehicle exterior member mounted on the actual vehicle. Such a liquid drop is exemplified by drops of rainwater and muddy water. The additive may be soluble in water or may be insoluble in water. The additive soluble in water is exemplified by glycerin and ethylene glycol. The additive insoluble in water is exemplified by: oils such as mineral oil and silicone oil; and minerals such as talc, mica, zeolite, and smectite. These additives may be used singly, or two or more types of these additives may be used in combination.

A method for adhering the test liquid drop onto the water-repellent coating film formed through the recoating step is not particularly limited, and the liquid only has to be adhered onto the water-repellent coating film on the coating-film-formed vehicle exterior member through any method. This liquid on the water-repellent coating film becomes the test liquid drop owing to surface tension.

The method for adhering the test liquid drop onto the water-repellent coating film formed through the recoating step may include, for example, merely dripping the above liquid onto the water-repellent coating film, applying the liquid onto the water-repellent coating film by using a brush or the like, or spraying the liquid onto the water-repellent coating film by using a spraying device. In any case, the liquid having such an amount as to trickle down is preferably adhered onto the water-repellent coating film.

As a method in which the fall-off angle of the test liquid drop is measured and a water-repellency assessment regarding the coating-film-formed vehicle exterior member is made, a method explained in an embodiment section described later may be employed, or a method in which the coating-film-formed vehicle exterior member onto which the test liquid drop has been adhered is tilted at a degree equivalent to the degree in this method and the state of the test liquid drop is monitored may be employed. Alternatively, the fall-off angle may be measured with reference to, for example, “Characterization of Water Repellency” disclosed in pages 21 to 26, No. 1, Vol. 60, issued in 2009 by the Journal of The Surface Finishing Society of Japan.

The coating-film-formed vehicle exterior member may be subjected to a water-repellency assessment alone or may be subjected to a water-repellency assessment in a state of being mounted on an actual vehicle. In order to make a water-repellency assessment under a condition based on the actual situation, the coating-film-formed vehicle exterior member is preferably subjected to a water-repellency assessment in a state of being mounted on an actual vehicle. Meanwhile, in order to easily and efficiently make a water-repellency assessment, the coating-film-formed vehicle exterior member is preferably subjected to a water-repellency assessment alone.

The coating-film-formed vehicle exterior member to be subjected to a water-repellency assessment may have the same shape as the shape of a coating-film-formed vehicle exterior member to be mounted on an actual vehicle or may be a mere test piece. In order to make an assessment under a condition based on the actual situation, the coating-film-formed vehicle exterior member preferably has the same shape as the shape of a coating-film-formed vehicle exterior member to be mounted on an actual vehicle.

In the condition setting method of the present invention, when the above fall-off angle is not greater than 20°, an assessment that the relevant recoating condition is an acceptable recoating condition is made. In consideration of the fact that a smaller fall-off angle indicates a higher water repellency, the fall-off angle for making an assessment that the relevant recoating condition is an acceptable recoating condition is preferably not greater than 19.5° and more preferably not greater than 19º.

When recoating is repeated, the amount of the water-repellent coating film remaining after the peeling step, the number or the sizes of flaws formed in a lower layer relative to the water-repellent coating film or the vehicle exterior member through the peeling step, or the like is increased, whereby the smoothness of a water-repellent coating film formed as an upper layer relative to the remaining water-repellent coating film, the lower layer, or the vehicle exterior member is predicted to be impaired. Therefore, when recoating is repeated an excessively large number of times, the water-repellent performance of the water-repellent coating film is considered to decrease, and the fall-off angle measured in a water-repellency assessment is considered to exceed 20°.

In a case where recoating has been appropriately performed, the fall-off angle of the test liquid drop in the assessment step is not greater than 20° when the number of times of recoating repetition is not greater than 4, as explained in detail in an embodiment section described later. Therefore, in order to more strictly assess a recoating condition, the assessment step is preferably performed after recoating has been performed four times.

The number of times of recoating is preferably up to 4 also in a case where a coating-film-formed vehicle exterior member mounted on an actual vehicle is subjected to recoating on the basis of a condition set through the condition setting method of the present invention. In other words, in the case where a coating-film-formed vehicle exterior member mounted on an actual vehicle is subjected to recoating on the basis of a condition set through the condition setting method of the present invention, recoating is preferably performed only when the number of times of recoating previously performed is not greater than 3.

Meanwhile, in the condition setting method of the present invention, the fall-off angle as a dynamic assessment criterion is employed in order to assess the water-repellent performance of the water-repellent coating film, as described above. In the condition setting method of the present invention, an assessment based on a contact angle as a static assessment criterion may be made in addition to an assessment based on the fall-off angle as a dynamic assessment criterion in order to more accurately assess the water-repellent performance. Specifically, the assessment step of the condition setting method of the present invention preferably includes making, when the contact angle of the test liquid drop is not less than 100°, an assessment that the relevant recoating condition is an excellent recoating condition which is a high-ranking recoating condition among the acceptable recoating conditions.

The contact angle mentioned herein means so-called wettability and is measured on the basis of JIS K 6768: 1999. As the liquid used for the test liquid drop, a liquid mixture disclosed in JIS K 6768: 1999 may be used, or the same liquid as the liquid used for measuring the fall-off angle may be used. When the contact angle of the test liquid drop is large, the angle formed between the surface of the coating-film-formed vehicle exterior member and the test liquid drop is considered to be large, the wettability of the coating-film-formed vehicle exterior member is considered to be low, and the coating-film-formed vehicle exterior member is considered to have excellent water repellency.

The assessment step preferably includes making, when the contact angle of the test liquid drop is not less than 102°, an assessment that the recoating condition is an excellent recoating condition and more preferably includes making, when the contact angle of the test liquid drop is not less than 105°, an assessment that the recoating condition is an excellent recoating condition.

Hereinafter, the condition setting method of the present invention is described by means of specific examples.

### Example 1

In a condition setting method in Example 1, a cover for covering a LiDAR mounted on a vehicle was employed as a vehicle exterior member. The condition setting method in Example 1 is a method for setting a condition for performing recoating with respect to a water-repellent coating film formed on a surface of the cover.

The condition setting method in Example 1 includes a preparation step, a peeling step, a recoating step, and an assessment step.

### [Preparation Step]

In the preparation step, a coating-film-formed vehicle exterior member obtained by forming a water-repellent coating film onto the surface of the vehicle exterior member was prepared.

As the vehicle exterior member, a vehicle exterior member including a base material made from polycarbonate and having a substantially flat plate shape and a hard coat layer formed on a surface of the base material, was used. The hard coat layer was formed by coating the base material with an acrylic urethane-based paint and drying and curing the acrylic urethane-based paint.

A material of a water-repellent coating film disclosed in JP2016-147469 (A) was further adhered onto the hard coat layer through dipping and was dried, whereby a coating-film-formed vehicle exterior member having the water-repellent coating film formed on the surface of the vehicle exterior member was prepared. The water-repellent coating film formed at this time had a film thickness of 200 nm.

### [Peeling Step]

The water-repellent coating film of the above coating-film-formed vehicle exterior member was wiped off with paper immersed in a water-soluble solvent. New Super Clean manufactured by Penguin Wax Co., Ltd. was used as the water-soluble solvent, and a commercially available paper wiper was used as the paper. An operator continued the wiping operation until the operator visually confirmed disappearance of the water-repellent coating film.

Then, an image of the surface of the vehicle exterior member was taken with a microscope and subjected to image processing, whereby the amount of the water-repellent coating film remaining on the surface of the vehicle exterior member was measured. The amount of the water-repellent coating film remaining on the surface of the vehicle exterior member was not greater than 2 area, and thus the water-repellent coating film was determined to have been sufficiently peeled.

### [Recoating Step]

On the vehicle exterior member having been subjected to the peeling step, a water-repellent coating film was formed in the same manner as in the preparation step, whereby a coating-film-formed vehicle exterior member resulting from the first time of recoating was obtained. The water-repellent coating film formed at this time is inferred to have had a film thickness of 200 nm equal to the film thickness in the preparation step.

### [Assessment Step]

Regarding the coating-film-formed vehicle exterior member resulting from the first time of recoating and obtained in the recoating step, a fall-off angle and a contact angle were measured. In measurement of the fall-off angle, water was used as the liquid for forming the test liquid drop. Meanwhile, the contact angle was measured on the basis of JIS K 6768: 1999, and the liquid mixture disclosed in JIS K 6768: 1999 was used as the liquid for forming the test liquid drop in measurement of the contact angle.

The fall-off angle was measured by using a contact angle meter that was manufactured by Kyowa Interface Science Co., Ltd. and that was equipped with a slide-down unit. The coating-film-formed vehicle exterior member was attached to a sample stage, and about 20 μL of minute test liquid drop was formed onto the water-repellent coating film by using a dispenser in which ion exchanged water was supplied. Then, while the test liquid drop was continuously imaged with a high-speed CCD camera, the sample stage was tilted from a horizontal state, and the angle of the sample stage was measured when the test liquid drop fell off. The angle of the sample stage at this time was regarded as a fall-off angle.

Regarding also the coating-film-formed vehicle exterior member not having been subjected to the peeling step, a fall-off angle and a contact angle were measured in advance.

Through the above steps, the first time of recoating was ended.

The above process from the peeling step to the assessment step was repeated three times, whereby second to fourth times of recoating were performed. This test was performed so as to satisfy n=2.

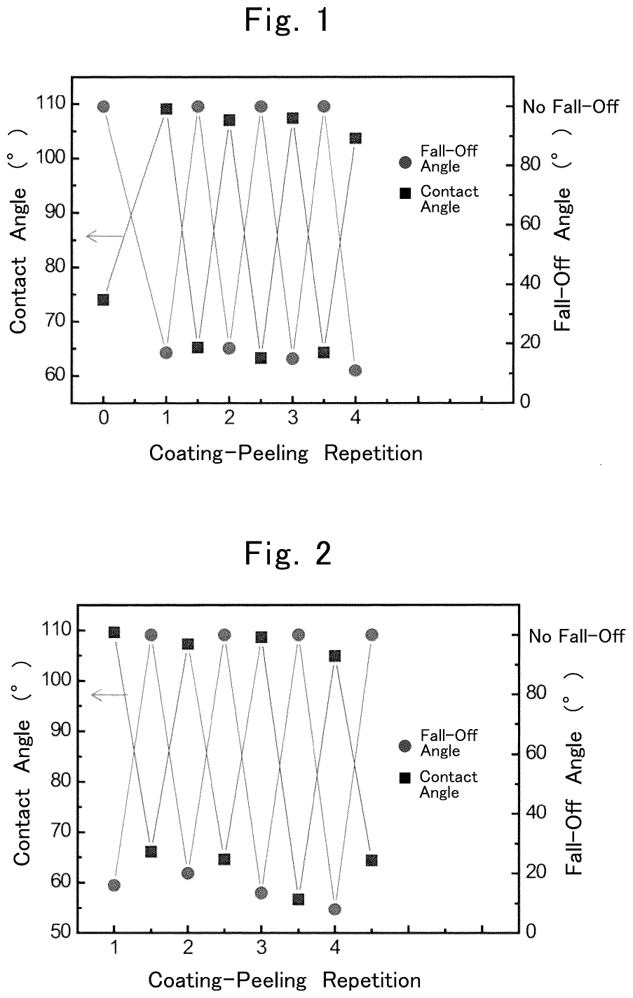

Regarding the coating-film-formed vehicle exterior members resulting from the first to fourth times of recoating, changes in the fall-off angle and the contact angle are shown in FIG. 1 and FIG. 2.

As shown in FIG. 1 and FIG. 2, the state where the fall-off angle was not greater than 20° and the contact angle was not less than 100° was maintained until the first to fourth times of recoating, and the water-repellent performance of each water-repellent coating film was sufficiently exhibited.

This result leads to the finding that, under a recoating condition in which the fall-off angle is not greater than 20°, a water-repellent coating film having sufficient water-repellent performance is formed through recoating. In addition, the result leads to the finding that, when the number of times of the recoating repetition is not greater than 4, sufficient water-repellent performance is imparted to the water-repellent coating film formed through recoating.

For reference, the transmissivity at 870 nm of each of the coating-film-formed vehicle exterior members resulting from the first to fourth times of recoating was measured. As a result, each of the coating-film-formed vehicle exterior members resulting from the first to fourth times of recoating had a transmissivity not less than 88%, i.e., had a sufficient transmissivity.

This result leads to the finding that, under a recoating condition in which the fall-off angle is not greater than 20°, a water-repellent coating film that is sufficiently smooth and that is suitable for being disposed on the outer side relative to a radar device is formed through recoating when the number of times of recoating repetition is not greater than 4.

The present invention is not limited to the embodiment described above and shown in the drawings, but may be modified as appropriate without deviating from the gist of the present invention. Furthermore, components described in the present specification including the embodiment may be optionally extracted and combined to be implemented.

1. A method for setting a condition for recoating a vehicle exterior member with a water-repellent coating film, the method comprising:
a peeling step of peeling a water-repellent coating film formed on a surface of the vehicle exterior member;
a recoating step of forming a water-repellent coating film onto the surface to obtain a coating-film-formed vehicle exterior member, the recoating step being subsequent to the peeling step; and
an assessment step of adhering a test liquid drop onto the water-repellent coating film formed through the recoating step, and making a water-repellency assessment, wherein
the assessment step includes making, when a fall-off angle of the test liquid drop is not greater than 20°, an assessment that a recoating condition used in the peeling step and the recoating step is an acceptable recoating condition.

2. The method for setting a recoating condition of a water-repellent coating film, according to claim 1, wherein the assessment step includes making, when a contact angle of the test liquid drop is not less than 100°, an assessment that the recoating condition used in the peeling step and the recoating step is an excellent recoating condition which is a high-ranking recoating condition among the acceptable recoating conditions.

3. A method for recoating, with a water-repellent coating film, a vehicle exterior member mounted on a vehicle, the method comprising:
a peeling step of peeling a water-repellent coating film formed on a surface of the vehicle exterior member;
a recoating step of forming a water-repellent coating film onto the surface to obtain a coating-film-formed vehicle exterior member, the recoating step being subsequent to the peeling step; and
an assessment step of adhering a test liquid drop onto the water-repellent coating film formed through the recoating step, and performing visual comparison with a standard article to make a water-repellency assessment regarding an actual vehicle.

4. A method for recoating, with a water-repellent coating film, a vehicle exterior member mounted on a vehicle, the method comprising:
a peeling step of, when the number of times of recoating previously performed on the vehicle exterior member is not greater than 3, peeling a water-repellent coating film formed on a surface of the vehicle exterior member; and
a recoating step of forming a water-repellent coating film onto the surface to obtain a coating-film-formed vehicle exterior member, the recoating step being subsequent to the peeling step.
